(19) United States
(12) Patent Application Publication
(10) Pub. No.: US 2020/0365325 A1
(43) Pub. Date: Nov. 19, 2020

(54) HEAT DISSIPATION STRUCTURE OF MULTILAYER CERAMIC CAPACITOR

(71) Applicant: HOLY STONE ENTERPRISE CO., LTD., Taipei (TW)

(72) Inventors: Chao-Kuang HSIAO, Taipei (TW); Chun-Yu SU, Taipei (TW); Shih-Jung WANG, Taipei (TW); Chen-Yang KAO, Taipei (TW)

(21) Appl. No.: 16/533,075

(22) Filed: Aug. 6, 2019

(30) Foreign Application Priority Data
May 13, 2019 (TW) 108205962

(51) Int. Cl. H01G 4/258; H01G 4/232

(52) U.S. Cl. CPC H01G 4/258; H01G 4/30; H01G 4/2325

(57) ABSTRACT

A heat dissipation structure of the multilayer ceramic capacitor is provided. The capacitor body includes ceramic dielectric layers stacked longitudinally, and inner electrodes disposed between and outside the ceramic dielectric layers and stacked in an interleaved manner, and two outer terminal electrodes disposed on two ends thereof and electrically connected to the inner electrodes. At least one pair of metal layers is disposed on an outer surface of the capacitor body in a minor symmetry, and extended inwardly from the two outer terminal electrodes. The metal layers on an upper cover of capacitor body can dissipate heat through a large area in contact or convection with air, and the metal layers on a lower cover can conduct heat to a circuit board for dissipating heat to the outside. Furthermore, the metal layers disposed on the upper and lower covers can increase a heat dissipation area.

This application claims the priority benefit of Taiwan patent application number 108205962, filed on May 13, 2019.

### BACKGROUND OF THE INVENTION

### 1. Field of the Invention

The present invention relates to a heat dissipation structure of a multilayer ceramic capacitor, and more particularly to a multilayer ceramic capacitor which includes a capacitor body having metal layers disposed on an upper cover thereof, a lower cover thereof, or both of the upper cover and the lower cover thereof, so that a metal heat dissipation area can be increased to dissipate heat accumulated by the multilayer ceramic capacitor, thereby delaying capacitance instability of the multilayer ceramic capacitor caused by temperature rise effect.

### 2. Description of the Related Art

In recent years, with advancement and rapid development of technology, capacitors are developed in a trend of miniaturization, high capacitance, high stability and reliability, and more capacitors are designed as chip-type multilayer ceramic capacitors (MLCC), which can have reduced sizes and production costs, and higher capacitance. Because of having various electrical characteristics applicable to the temperature ranges of most consumer electronics applications, the multilayer ceramic capacitors are widely used in various electronic products.

However, when the multilayer ceramic capacitor is applied under an alternating electric field, a temperature rise phenomenon occurs because the ferroelectric domain of the dielectric material changes direction with the electric field. When the multilayer ceramic capacitor is operated with high-frequency or low-frequency current for a long time, and the high temperature of the heat accumulated by the capacitor body gradually approaches the Curie temperature range of the dielectric material, the temperature coefficient of capacitance (TCC) curve fluctuate, in other words, the change in the capacitance varies more greatly with temperature. When the temperature of the multilayer ceramic capacitor is too high, the capacitor body of the multilayer ceramic capacitor accumulates a lot of heat, which affects operation stability of the multilayer ceramic capacitor and even resonates with a certain frequency harmonic in the alternating electric field to cause serious damage to the system. Furthermore, the environmental temperature is closely related to whether the multilayer ceramic capacitor can work normally, and the working temperature of the multilayer ceramic capacitor also has a significant impact on dielectric loss, insulation resistance, dielectric temperature stability and durability. In general, the durability of a capacitor is shortened with increasing of working temperature, so the capacitor must be designed with consideration of the effect of temperature on durability, so as to ensure the capacitor to operate normally for a long time.

Furthermore, as the technology in the field of capacitors is fully developed, the part of the capacitor structure that can be modified is limited, so the conventional technique is usually to increase the Curie temperature of the capacitor or reduce the fluctuation curvature of the temperature-temperature coefficient of capacitance (TCC) curve by changing the composition of the dielectric material including barium titanate and adding at least one special element. However, the manner of changing the material composition always has a problem in that it is not easy to accurately control the material composition during the production process. Furthermore, in recent years, a technique of additionally forming an aperture structure for controlling air convection on the capacitor body to dissipate heat, is developed. The high-temperature heat accumulated by the conventional ceramic capacitor can be mainly dissipated through the aperture structure which is only formed on an upper cover of the capacitor body. If the aperture structure is formed on a lower cover of the capacitor body, the aperture rate, which is a ratio of the volume occupied by apertures to a total volume of the multiplayer ceramic capacitor, is reduced because the apertures are filled fully by solder paste after the multilayer ceramic capacitor is soldered to a circuit board, as a result, the aperture structure does not work. Obviously, the aperture structure is not applicable to SMT process. Furthermore, when the heat of the capacitor is dissipated through only the aperture structure on the upper cover of the capacitor body, the heat dissipation efficiency is not high as expected, so the operation stability of the multilayer ceramic capacitor is still affected. Therefore, how to solve above-mentioned problems in heat dissipation of the multilayer ceramic capacitor is an important issue in the industry.

### SUMMARY OF THE INVENTION

Therefore, in order to solve the above-mentioned problems and drawbacks, the inventors develop a heat dissipation structure of a multilayer ceramic capacitor according to collected data, multiple tests and modifications, and years of research experience.

An objective of the present invention is that outer terminal electrodes at two ends of a capacitor body of the multilayer ceramic capacitor can have at least one metal layer extended inwardly, disposed on at least one outer side of the capacitor body in mirror symmetry, and spaced apart from each other by an interval, and the at least one metal layer has a flat and dense surface. The metal layer on at least one of an upper cover and a lower cover can be selected to coat solder paste for soldering to a circuit board. As a result, the multilayer ceramic capacitor of the present invention is applicable to a surface mount technology (SMT) process, and the degree of production freedom can be greatly increased and the high-temperature heat accumulated by the multilayer ceramic capacitor can be dissipated by increasing the metal heat dissipation area. Besides using the metal layer on the upper cover to be in contact or convection with air by a large area to dissipate heat, the metal layer on the lower cover can also be used to conduct heat most quickly and efficiently to a circuit board for dissipation to the outside; or the metal layers disposed on the upper cover and the lower cover can be used to dissipate heat at the same time, so as to delay the capacitance instability of the multilayer ceramic capacitor subject to the temperature rise phenomenon.

Another objective of the present invention is that in the process of manufacturing the outer terminal electrodes of the two ends of the capacitor body, each pair of metal layers can be directly formed by or integrated with the two outer terminal electrodes, which are formed by copper, silver, nickel or tin; for example, the outer terminal electrodes can be immersed to form a copper or silver layer, or electroplated to form at least one of a nickel layer and a tin layer. In an embodiment, in the outer terminal electrode process, each of metal layers can have a dense metal layer formed on the surface of capacitor body and in contact with the outer terminal electrode, so that the part where the SMT process is performed on the outer terminal electrode to bond on the circuit board is not affected, and the multilayer ceramic capacitor can be applied to the SMT process, thereby ensuring a yield rate of the multilayer ceramic capacitor used as a surface mount device (SMD). Furthermore, since each of the parts of the circuit board for the solder paste of the SMT bonding has a certain area and the positions of the parts for soldering with the outer terminal electrodes are fixed, the metal layers can still quickly conduct heat to the circuit board for heat dissipation through the outer terminal electrodes.

Another objective of the present invention is that the metal layer of each outer terminal electrode can be in a rectangular, semi-circular, semi-elliptical, polygonal or other suitable shape, and a corner of the metal layer can be a circular corner, an arc-shaped corner, a right-angled corner, or a chamfered corner, or a specific shape which can be made upon the complexity of the existing outer terminal electrode process. The metal layers on any one of the upper cover and lower cover can be directly formed using the outer terminal electrode process, and also must be arranged in mirror symmetry, so as to prevent the Tomb stone effect or Manhattan effect from occurring at the two ends of the multilayer ceramic capacitor because of different melting rates and the surface tension unbalance of the solder paste caused by uneven heating of the solder paste of the outer terminal electrodes during the reflow process of the SMT process due to the difference in metal layer shape or area.

### BRIEF DESCRIPTION OF THE DRAWINGS

The structure, operating principle and effects of the present invention will be described in detail by way of various embodiments which are illustrated in the accompanying drawings.

FIG. 1 is an elevational view of a multilayer ceramic capacitor of the present invention.

FIG. 2 is a top view of a multilayer ceramic capacitor of the present invention.

FIG. 3 is a sectional front view of a multilayer ceramic capacitor of the present invention.

FIG. 4 is a sectional front view of a multilayer ceramic capacitor soldered on a circuit board, according to the present invention.

FIG. 5 is a temperature-rise versus ripple current curve diagram (A) of a multilayer ceramic capacitor measured under low-frequency working environment, according to the present invention.

FIG. 6 is a data table (A) of the temperature-rise versus ripple current curve of FIG. 5, according to the present invention.

FIG. 7 is a temperature-rise versus ripple current curve diagram (B) of a multilayer ceramic capacitor measured under low-frequency working environment, according to the present invention.

FIG. 8 is a data table (B) of the temperature-rise versus ripple current curve of FIG. 7, according to the present invention.

FIG. 9 is a temperature-rise versus ripple current curve diagram (B) of a multilayer ceramic capacitor measured under low-frequency working environment, according to the present invention.

FIG. 10 is a data table (C) of the temperature-rise versus ripple current curve of FIG. 9, according to the present invention.

FIG. 11 is a temperature-rise versus ripple current curve diagram of a multilayer ceramic capacitor measured under high-frequency working environment according to the present invention.

FIG. 12 is a data table of the temperature-rise versus ripple current curve of FIG. 11, according to the present invention.

FIG. 13 is a top view of another embodiment of a multilayer ceramic capacitor of the present invention.

FIG. 14 is a top view of another embodiment of a multilayer ceramic capacitor of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that although the terms ‘first’ ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

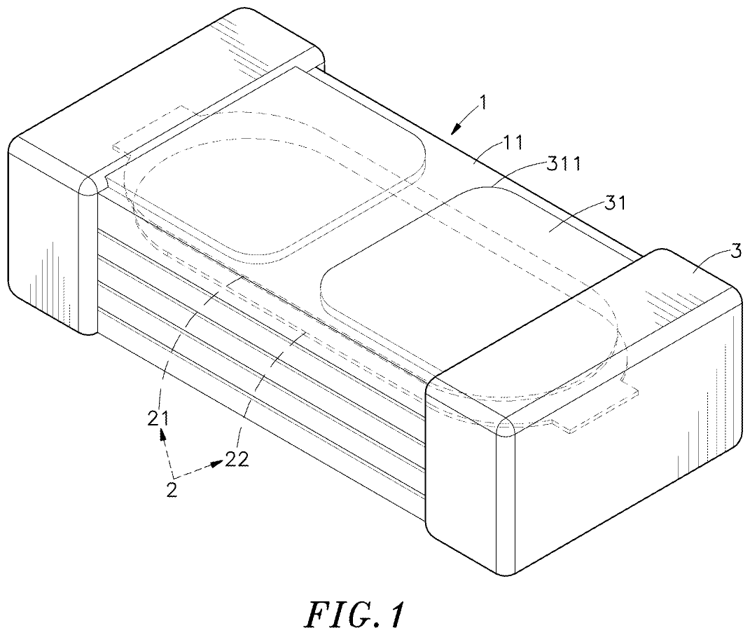

Please refer to FIGS. 1 to 4, which are an elevational view, a top view and a sectional front view of a multilayer ceramic capacitor of the present invention, and a sectional front view of the multilayer ceramic capacitor soldered on a circuit board, respectively. As shown in FIGS. 1 to 4, the multilayer ceramic capacitor includes a capacitor body 1, a plurality of inner electrodes 2, and two outer terminal electrodes 3. The capacitor body 1 comprises a plurality of ceramic dielectric layers 11 stacked longitudinally, and the plurality of inner electrodes 2 are disposed on two opposite inner side surfaces of each two adjacent ceramic dielectric layers 11 and stacked in an interleaved manner. A terminal of each inner electrode 2 is exposed out of two ends of the capacitor body 1. The two outer terminal electrodes 3 are formed on two ends of the capacitor body 1 and electrically connected to the terminals of the inner electrodes 2, respectively. At least one pair of metal layers 31 is extended inwardly from the two outer terminal electrodes 3 and used for heat dissipation, and the metal layers 31 are disposed on at least one outer side surface of the capacitor body 1, arranged in mirror symmetry, and spaced apart from each other by an interval.

In the embodiment, the plurality of inner electrodes 2 are arranged between and outside of the ceramic dielectric layers 11 of the capacitor body 1, respectively, and stacked in an interleaved manner. The plurality of inner electrodes 2 comprise first inner electrodes 21 and second inner electrodes 22 stacked in an interleaved manner. In an embodiment, the plurality of inner electrodes 2 can have the first inner electrodes 21, the second inner electrodes 22, and floating electrodes which are not connected to any one of the outer terminal electrodes 3, so that the first inner electrodes 21 or the second inner electrodes 22 can be paired, and disposed coplanarly with the ceramic dielectric layers 11, and spaced apart from each other by an interval. It should be noted that each of the floating electrodes is disposed on a different plane from another adjacent ceramic dielectric layer 11, so the floating electrodes and the ceramic dielectric layers 11 will be described together in the following description of the present invention.

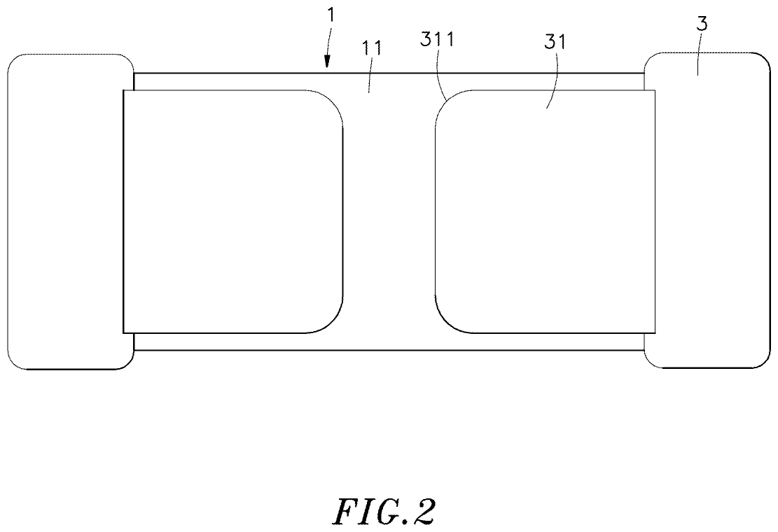

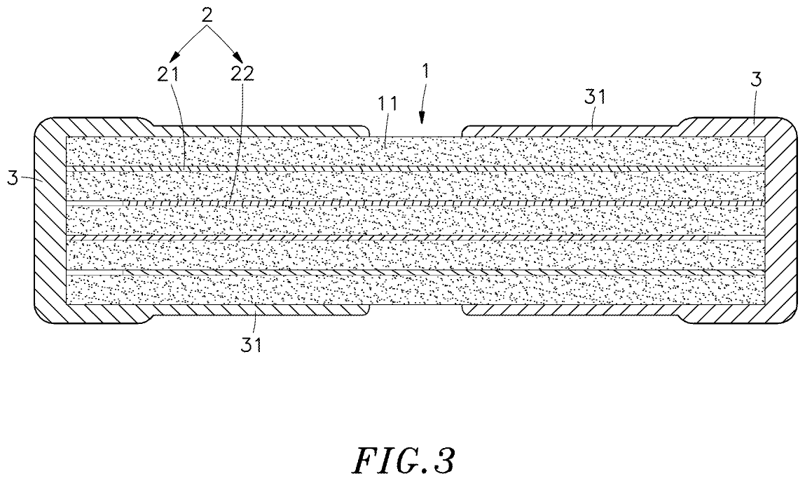

As shown in FIGS. 2 and 3, the bottom view of the multilayer ceramic capacitor of the present invention is symmetrical with the top view of the multilayer ceramic capacitor of the present invention, so the bottom view is omitted herein. The ceramic dielectric layers 11 on the top and bottom of the capacitor body 1 can form the upper cover and the lower cover, respectively, and each of the upper cover and the lower cover is provided with the metal layers 31 formed on outer surfaces thereof and extended inwardly from the two outer terminal electrodes 3. However, in actual application, the two metal layers 31 can be disposed on the outer surface of one of the upper cover and the lower cover, and the two metal layers 31 are arrange in mirror symmetry with respect to a center line of the multilayer ceramic capacitor in a length direction, and the two metal layers 31 are axisymmetric, so that even when the two metal layers 31 are exchanged in position, the shapes and sizes of the two metal layers 31 are still the same.

In a general process of manufacturing the outer terminal electrodes 3 of the multilayer ceramic capacitor, the ends of the capacitor body 1 are immersed in copper or silver glue to form a copper layer or a silver layer, and after a sintering process, the copper or silver layer is plated to form a nickel layer and a tin metal layer in a sequential order. In an embodiment, each pair of the metal layers 31 can be formed directly from the copper layer, the silver layer, or at least one of the nickel layer and the tin layer, by using the existing outer terminal electrode process, but the present invention is not limited to this examples. In other embodiment, the pair of metal layers 31 can be integrally formed with the outer terminal electrodes 3 according to different processes; in other embodiment, a flat and dense metal layer can be formed on the surface of the capacitor body 1 and configured to be in connection or contact with the outer terminal electrodes 3, in other words, the metal layer 31 can have a flat and dense surface. The metal layer 31 and the outer terminal electrode 3 can be made by the same material, such as copper, silver, nickel, tin or other metals alloy material. In other embodiment, the metal layer 31 and the inner electrode 2 can be made by the same material, such as nickel and tin, preferably. As a result, the parts where the surface mount technology (SMT) is performed to bond the outer terminal electrodes 3 on a circuit board 4 are not affected by the metal layers 31, and the multilayer ceramic capacitor of the present invention is applicable to the SMT process, so as to ensure a yield of the multilayer ceramic capacitor used as a surface mount device (SMD). It should be noted that various equivalent structural changes, alternations or modifications based on the descriptions and figures of present disclosure are all consequently viewed as being embraced by the spirit and the scope of the present disclosure set forth in the claims.

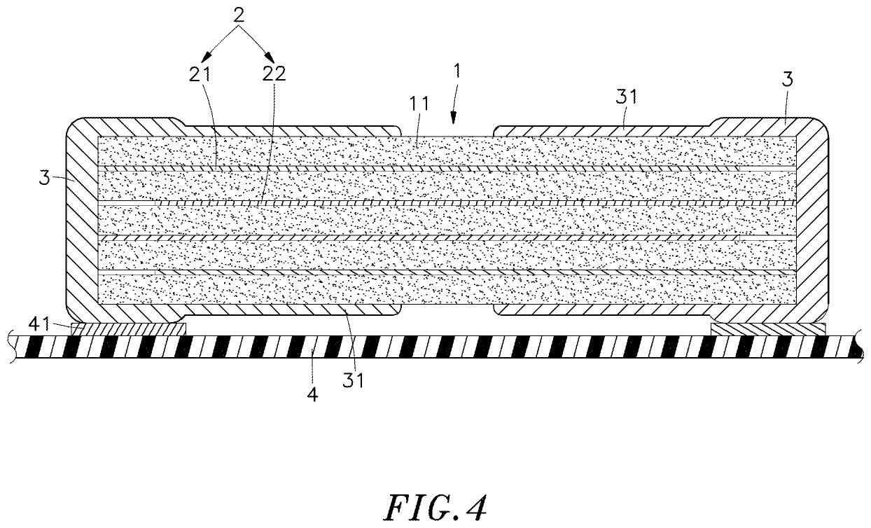

As shown in FIG. 4, the capacitor body 1 includes the metal layers 31 disposed on the two side surfaces of the upper cover and the lower cover thereof and extended inwardly from the two outer terminal electrodes 3, and arranged in mirror symmetry and spaced apart from each other by an interval. Any one of the upper cover and the lower cover can be selected as the part for coating a solder paste 41 for soldering the multilayer ceramic capacitor on the circuit board 4, so that the multilayer ceramic capacitor of the present invention can be applicable to the SMT process, and the degree of the production freedom of the SMT process can also be greatly increased. When an alternating current, transmitted from an electronic circuit, flows through the multilayer ceramic capacitor, the heat generated in the capacitor body 1 of the multilayer ceramic capacitor can be directly conduced to each of the metal layers 31, and the heat of each inner electrode 2 can be conducted to the metal layers 31 through the two outer terminal electrodes 3, so that the metal heat dissipation area can be increased to efficiently dissipate the high-temperature heat accumulated in the multilayer ceramic capacitor. Besides using the metal layers 31 on the upper cover to be in contact or convection with air to dissipate heat, the metal layers 31 on the lower cover can also be used to quickly conduct the high-temperature heat accumulated in the capacitor body 1 to the circuit board 4 through the two outer terminal electrodes 3 in the most efficient heat conduction manner, so as to dissipate heat to the outside. Therefore, the capacitance instability of the multilayer ceramic capacitor subject to the temperature rise phenomenon during operation can be effectively delayed; more particularly, the effect occurring when the temperature of the capacitor body 1 gradually approaches the Curie temperature can be delayed, so that the relationship between a temperature coefficient of capacitance (TCC) and temperature can be gentler, the multilayer ceramic capacitor of the present invention is not easy to accumulate heat, and the fluctuation of the TCC curve of the multilayer ceramic capacitor of the present invention is more stable. Furthermore, the metal layers 31 on the lower cover can reinforce the multilayer ceramic capacitor to resist the cracking damage caused by vibration of the circuit board 4.

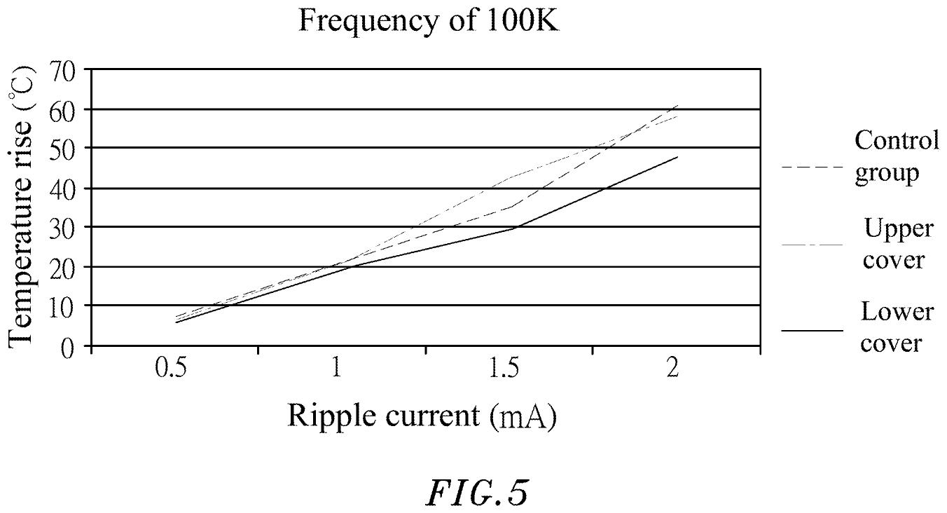

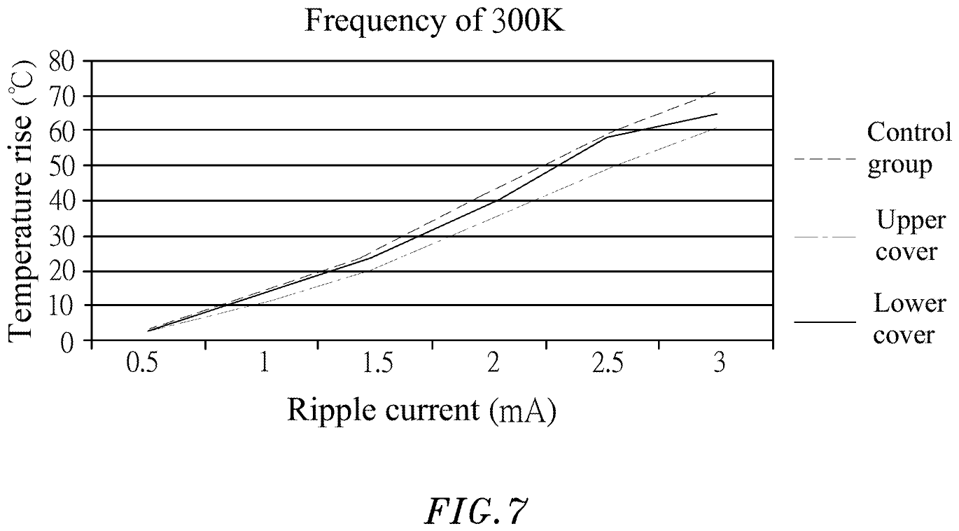

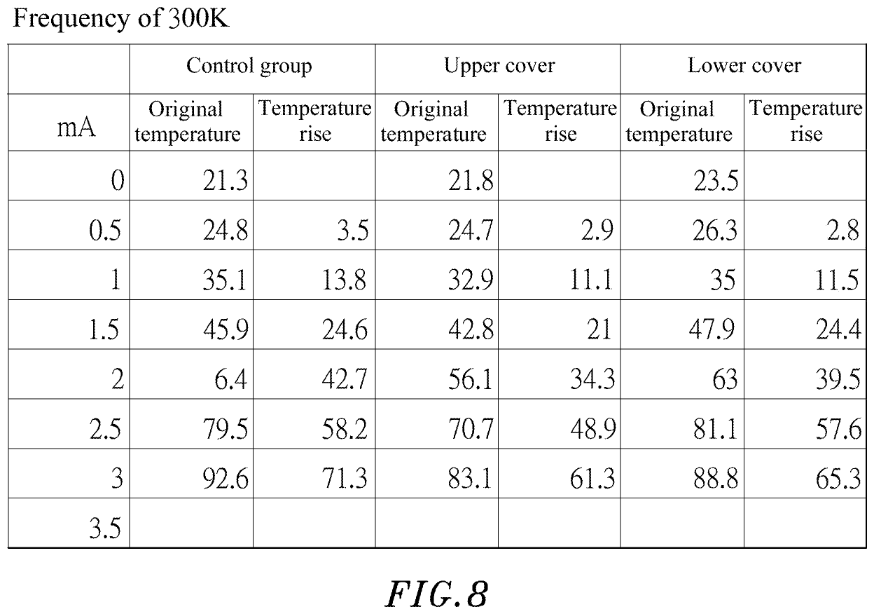

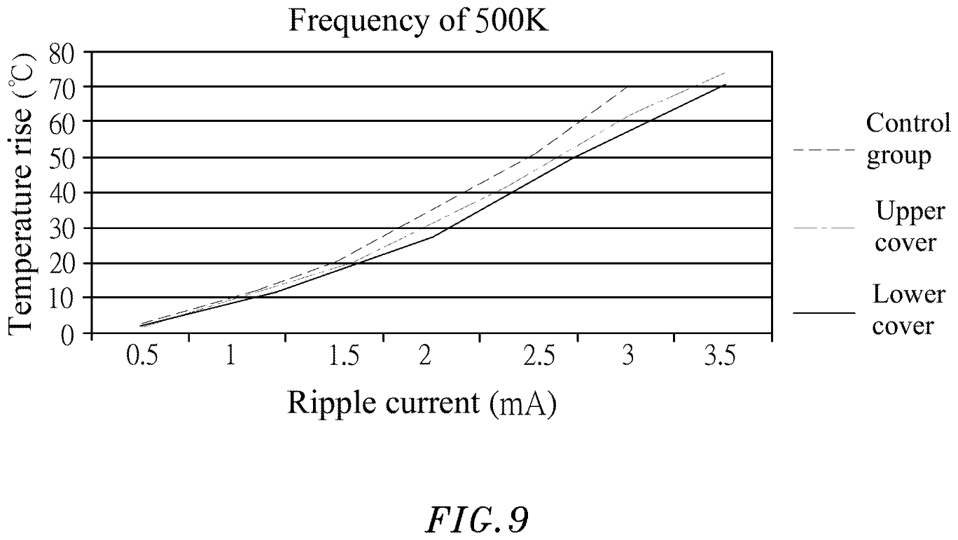

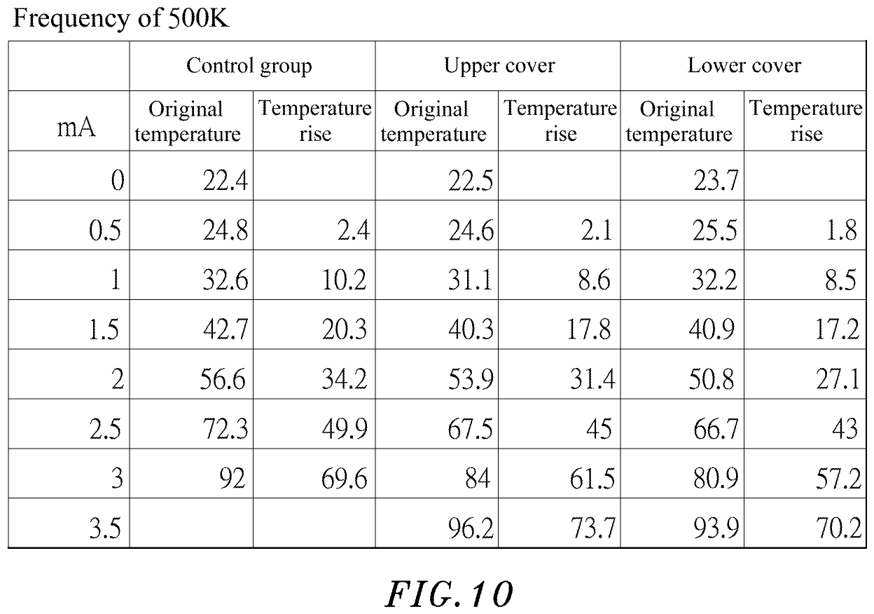

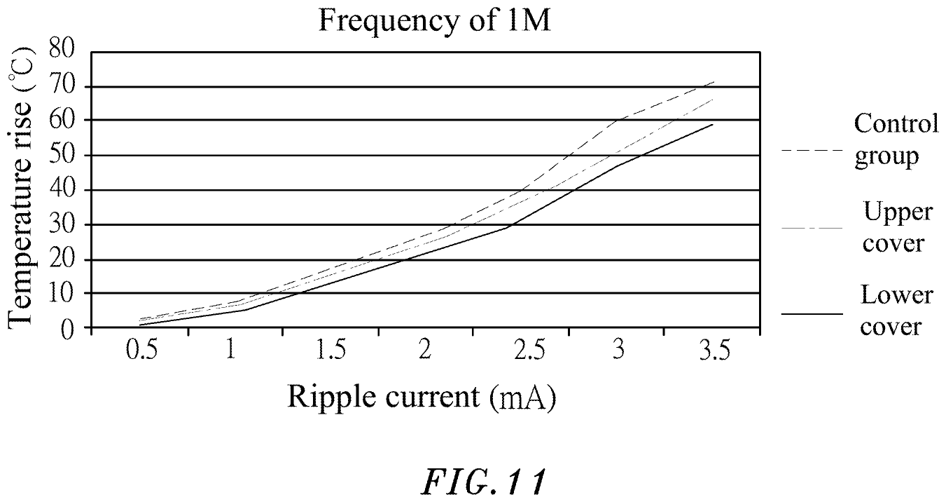

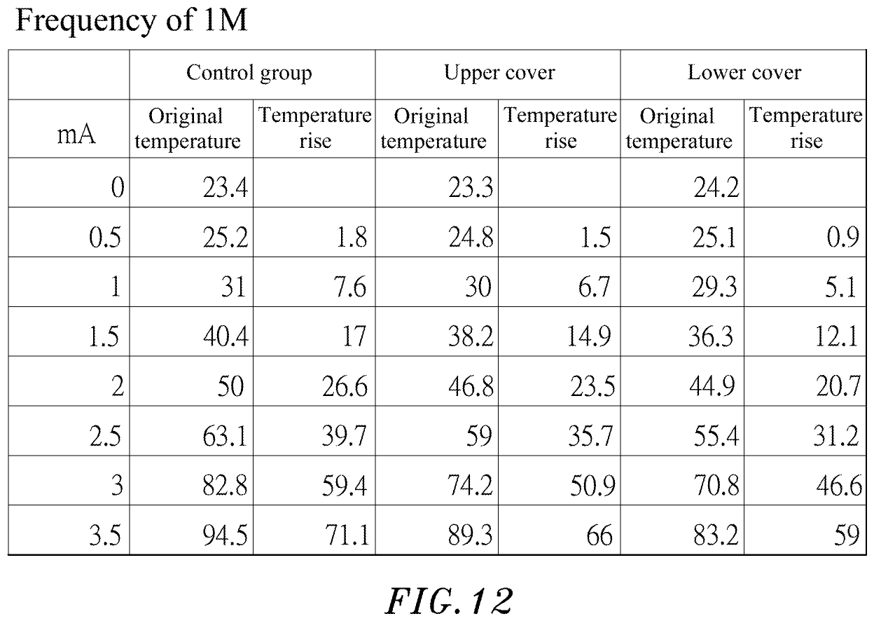

Please refer to FIGS. 5 to 12, which are a temperature-rise versus ripple-current curve diagram (A) of a multilayer ceramic capacitor measured under low-frequency working environment, a data table (A) of the temperature-rise versus ripple-current curve of FIG. 5, a temperature-rise versus ripple-current curve diagram (B) of a multilayer ceramic capacitor measured under the low-frequency working environment, a data table (B) of the temperature-rise versus ripple-current curve of FIG. 7, a temperature-rise versus ripple-current curve diagram (B) of a multilayer ceramic capacitor measured under the low-frequency working environment, a data table (C) of the temperature-rise versus ripple-current curve of FIG. 9, and a temperature-rise versus ripple-current curve diagram of a multilayer ceramic capacitor measured under high-frequency working environment according to the present invention, respectively. As shown in FIGS. 5 to 12, in order to understand the effect caused by the rectified current of alternating current (AC), flowing through the multilayer ceramic capacitor, on the heat characteristic of the multilayer ceramic capacitor when the multilayer ceramic capacitor is applied in the low-frequency or high-frequency working environment, a temperature-rise versus ripple current curve of the multilayer ceramic capacitor with the specification of 0402, which defines a length and a width, is measured. In order to strictly measure the heat dissipation effect of the embodiment of the multilayer ceramic capacitor of the present invention, the metal layers 31 on only one of the upper cover or the lower cover of the capacitor body 1 are used for heat dissipation, instead of using the metal layers 31 on both of the upper cover and the lower cover for heat dissipation at the same time.

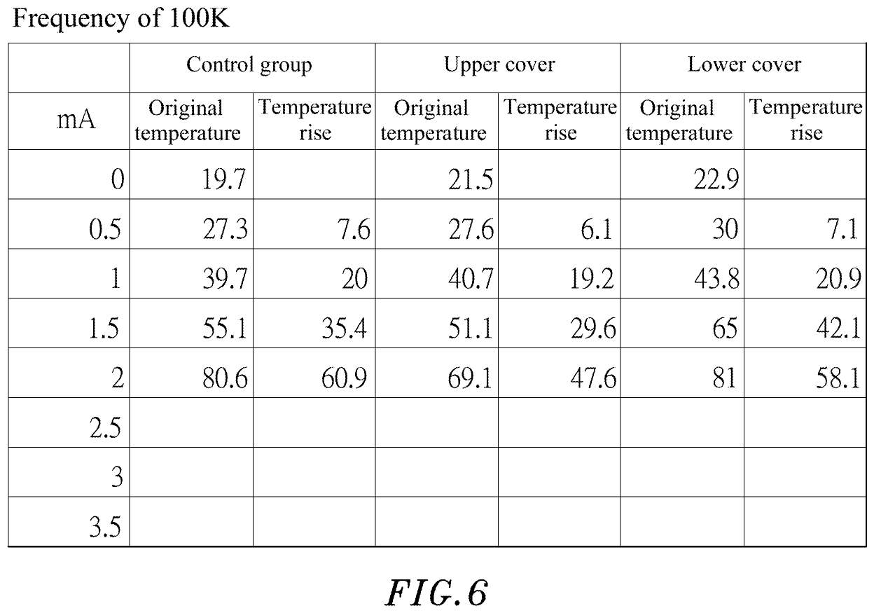

Furthermore, as shown in FIGS. 6, 8, 10 and 12 which are experimental data tables measured during operations of the multilayer ceramic capacitor of the embodiment of the present invention and control groups under the conditions with frequencies 100K, 300K, 500K, and 1M, respectively. Each of the multilayer ceramic capacitors of the control groups has only outer terminal electrodes at two ends thereof. According to the temperature-rise curves shown in FIGS. 5, 7, 9 and 11, the experimental data shows that, compared with the multilayer ceramic capacitors of the control groups having no heat dissipation structure, the rising temperature of the capacitor body 1 of the embodiment of the present invention using the metal layers 31 on the upper cover or the lower cover has a tendency to decrease when the ripple current increases, under the conditions with frequencies of 100K 300K, 500K and 1M and the multilayer ceramic capacitor being operated for 3 hours; in other words, the rising temperature of the multilayer ceramic capacitor of the present invention is significantly lower than that of the control groups. For example, under the condition with the frequency of 100K Hz and ripple current of 2 mA, the rising temperature of 47.6° C. measured on the multilayer ceramic capacitor of the present invention is lower than the rising temperature of 60.9° C. measured in the control group by at least 10° C.; under the condition with a frequency of 1M Hz and a ripple current of 3.5 mA, the rising temperature of 59° C. measured on the multilayer ceramic capacitor of the present invention is lower than the rising temperature 71.1° C. measured in the control group by at least 10° C., and it can estimate a more obvious cooling effect on the multilayer ceramic capacitor of the present invention after the multilayer ceramic capacitor of the present invention is operated longer.

Furthermore, when the capacitor body 1 dissipates heat through the metal layers 31 on both of the upper cover and the lower cover at the same time, the cooling effect can be better. Therefore, the configuration of the pair of metal layers 31 of the multilayer ceramic capacitor of the present invention can increase the metal heat dissipation area to dissipate the accumulated high-temperature heat, so as to more effectively control the temperature of the multilayer ceramic capacitor compared with the multilayer ceramic capacitor not having any heat dissipation structure, and the multilayer ceramic capacitor of the present invention is not easy to accumulate heat and the fluctuation of the TCC curve of the multilayer ceramic capacitor of the present invention is more stable, thereby delaying the capacitance instability of the multilayer ceramic capacitor subject to the temperature rise phenomenon.

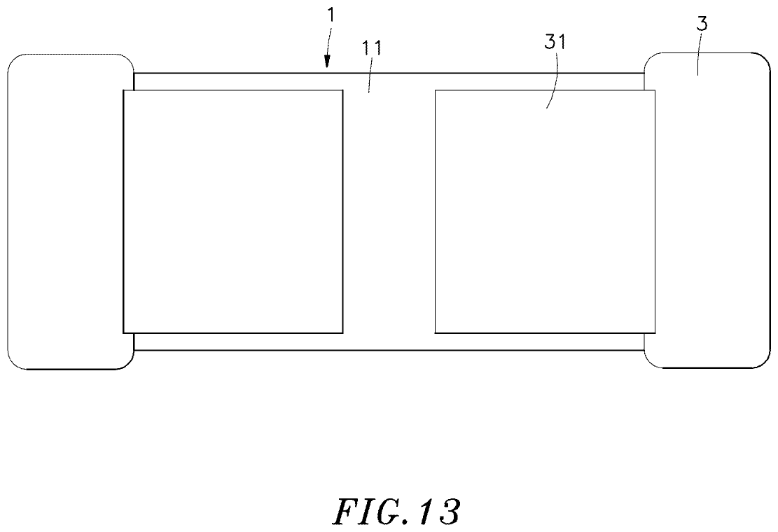

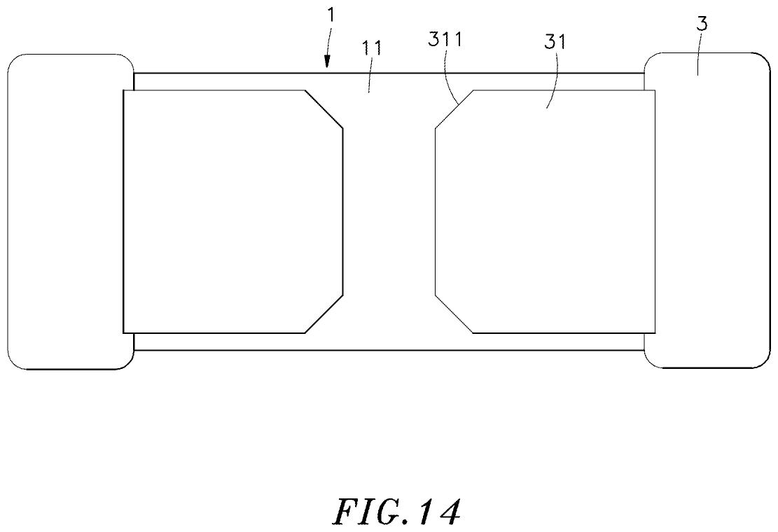

Please refer to FIGS. 13 and 14, which are top views of two embodiments of a multilayer ceramic capacitor of the present invention, respectively. As shown in FIGS. 13 and 14, the bottom view of the multilayer ceramic capacitor of the present invention is symmetrical with the top view of the multilayer ceramic capacitor of the present invention, so the bottom view is omitted. The capacitor body 1 has at least one pair of metal layers 31 disposed on the upper and lower sides of the ceramic dielectric layer 11 and extended inwardly from the two outer terminal electrodes 3. The upper and lower sides of the ceramic dielectric layers 11 are the upper cover and the lower cover of the capacitor body 1, respectively. The two metal layers 31 are arranged in minor symmetry and spaced apart from each other by an interval, and a length of each metal layer 31 along a width direction of the capacitor body 1 is shorter than that of each outer terminal electrode 3, and the thickness of each metal layer 31 can also be thinner than that of each outer terminal electrode 3. The part of the circuit board 4 for coating the solder paste 41 for the SMT bonding process has a certain area, and positions of the soldering parts of the outer terminal electrodes 3 are fixed, so the metal layers 31 on the lower cover does not affect the part where the heat is accumulated originally. Since there is still a certain interval formed between the metal layers 31 and the circuit board 4, heat can be quickly conduct to the circuit board 4 through the outer terminal electrodes 3 and the metal layers 31, for dissipation.

In the embodiment, each metal layer 31 on at least one of the upper cover and the lower cover of the capacitor body 1 can be in a rectangular shape, but the present invention is not limited to this examples; in other embodiment, the metal layer 31 can be in a semicircular or semi-elliptical shape, or in a polygonal shape such as trapezoid, pentagon, hexagon, and so on. Each of four corners 311 of inner sides of the pair of metal layers 31 can be a circular corner as shown in FIG. 2, an arc corner, or a right-angled corner as shown in FIG. 13, or a chamfered corner as shown in FIG. 14. In other embodiment, the metal layer 31 of a specific shape can be produced according to complexity of the existing outer terminal electrode process. Besides directly forming the metal layers 31 on one of the upper cover and the lower cover of the capacitor body 1 by using the manufacturing process of the outer terminal electrode 3, the metal layers 31 must also be arranged in minor symmetry to prevent the two ends of the multilayer ceramic capacitor from occurring the Tomb stone effect or Manhattan effect which is caused by different melting rate and surface tension unbalance of the solder paste 41 of the outer terminal electrodes 3 heated unevenly during reflow process in the SMT process because of the difference in shapes or areas of the metal layers 31.

Compared with the conventional multilayer ceramic capacitor, the multilayer ceramic capacitor of the present invention has the following advantages.

First, the outer terminal electrodes 3 at the two ends of the capacitor body 1 of the present invention have at least one pair of metal layers 31 disposed on the outer surface of one of the upper cover and the lower cover, or the outer surfaces of both of the lower cover and the upper cover of the ceramic dielectric layer 11 and extended inwardly, so as to increase the metal heat dissipation area for dissipating the accumulated high temperature heat; besides using the metal layers 31 on the upper cover to be in contact or convection with air to dissipate heat, the metal layers 31 on the lower cover can also be used to most efficiently conduct heat to the circuit board 4 for dissipating heat to the outside; furthermore, the metal layers 31 disposed on both of the upper cover and the lower cover can dissipate heat at the same time, to provide better cooling effect, so as to delay the capacitance instability of the multilayer ceramic capacitor subject to the temperature rise phenomenon, and more particularly delay the effect occurring when the temperature of the capacitor body 1 gradually approaches the Curie temperature.

Secondly, in the process of manufacturing the outer terminal electrodes 3 at two ends of the capacitor body 1 of the present invention, the at least one pair of metal layers 31 can be directly formed by or integrally formed with the outer terminal electrodes 3, and the metal layers 31 are disposed on at least one outer side of the capacitor body 1 in mirror symmetry, so that the metal layers 31 on at least one of the upper cover and the lower cover can be selected as the portion where the solder paste 41 is applied when the multilayer ceramic capacitor is soldered to the circuit board 4, and it does not affect the portions where the outer terminal electrodes 3 are bonded on the circuit board 4 through SMT process; as a result, the multilayer ceramic capacitor can be applied to the SMT process, and the degree of production freedom be significantly increased, thereby ensuring the yield rate of the multilayer ceramic capacitor used as a surface mount device. Furthermore, the metal layers 31 on the lower cover can also reinforce the multilayer ceramic capacitor to resist the cracking damage caused by the vibration of the circuit board 4.

Thirdly, compared with the multilayer ceramic capacitors of the control groups not having any heat dissipation structure, the metal layers 31 on at least one of the upper cover and the lower cover can provide the cooling effect of at least 10° C. with the increase of ripple current under the low-frequency or high-frequency operating environment, and it can estimate to have a more significant cooling effect when the multilayer ceramic capacitor of the present invention is operated for a longer time; furthermore, when the capacitor body 1 dissipates heat through the metal layers 31 on both of the upper cover and the lower cover at the same time, the cooling effect can be more better, so that the temperature coefficient curve of the capacitor has a trend to be more gradual, the multilayer ceramic capacitor of the present invention is not easy to accumulate heat, and fluctuation of the TCC curve of the multilayer ceramic capacitor of the present invention can be more stable.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A heat dissipation structure of a multilayer ceramic capacitor, comprising:
a capacitor body comprising a plurality of ceramic dielectric layers stacked longitudinally;
a plurality of inner electrodes disposed between and outside the plurality of ceramic dielectric layers, respectively, and stacked in an interleaved manner; and
two outer terminal electrodes disposed on two ends of the capacitor body and electrically connected to terminals of the plurality of inner electrodes, respectively, wherein the two outer terminal electrodes have at least one pair of metal layers extended inwardly relative to each other and for heat dissipation, and the metal layers are disposed on at least one outer surface of a side of the capacitor body in mirror symmetry, and spaced apart from each other by an interval, and the metal layers have flat and dense surfaces.

2. The heat dissipation structure according to claim 1, wherein the capacitor body has the metal layers disposed on the outer surfaces of upper and lower sides of the ceramic dielectric layer, extended inwardly relative to each other from the two outer terminal electrodes.

3. The heat dissipation structure according to claim 2, wherein the pair of metal layers are in contact with the outer terminal electrodes, respectively, and made by copper, silver, nickel, or tin, and each of the metal layers is in a rectangular, semicircular, semi-elliptical shape, or in a polygonal shape.

4. The heat dissipation structure according to claim 3, wherein each of the metal layers has two corners on the opposite inner sides thereof, and each of the two corners is a circular corner, an arc corner, or a chamfered corner.

5. The heat dissipation structure according to claim 1, wherein the capacitor body has the pair of metal layers disposed on an outer surface of one of the plurality of ceramic dielectric layers at an upper part thereof, extended inwardly relative to each other from the two outer terminal electrodes.

6. The heat dissipation structure according to claim 5, wherein the pair of metal layers is in contact to the outer terminal electrodes, respectively, and made by copper, silver, nickel, or tin, and each of the metal layers is in a rectangular, semicircular, or semi-elliptical shape, or in a polygonal shape.

7. The heat dissipation structure according to claim 6, wherein each of the metal layers has two corners on opposite inner sides thereof, and each of the two corners is a circular corner, an arc corner, or a chamfered corner.

8. The heat dissipation structure according to claim 1, wherein the capacitor body has the pair of metal layers disposed on an outer surface of the ceramic dielectric layer at a lower part thereof, and extended inwardly relative to each other from the two outer terminal electrodes, respectively.

9. The heat dissipation structure according to claim 8, wherein the pair of metal layers is in contact to the outer terminal electrodes, respectively, and made by copper, silver, nickel, or tin, and each of the metal layers is in a rectangular, semicircular, semi-elliptical shape, or in a polygonal shape.

10. The heat dissipation structure according to claim 9, wherein each of the metal layers has two corners on the opposite inner sides thereof, and each of the two corners is a circular corner, an arc corner, or a chamfered corner.
